(19) United States
(12) Patent Application Publication
(10) Pub. No.: US 2025/0021710 A1
(43) Pub. Date: Jan. 16, 2025

(54) Computer-Implemented Method for Positioning Elements in a Space of a Building

(71) Applicant: Siemens Schweiz AG, Zuerich (CH)

(72) Inventors: Kevin BAUER, Wien (AT); Fabian PITSCHEIDER

(21) Appl. No.: 18/715,355

(22) PCT Filed: Nov. 30, 2022
(86) PCT No.: PCT/EP2022/083915

§ 371 Date: Jun. 4, 2024

(30) Foreign Application Priority Data
Dec. 2, 2021 (EP) 21211880.6

(51) Int. Cl. G06F 30/13; G06F 30/27; G06F 111/06

(52) U.S. Cl. CPC G06F 30/13; G06F 30/27; G06F 2111/06

(57) ABSTRACT

A computer-implemented method for positioning technical elements in a space, wherein the elements each have an element work area, where the method includes a) providing the geometry of the space via a space model, b) determining a set of possible element positions for positioning elements from the space model taking into account predetermined positioning rules for the space, c) ascertaining the number of elements for the space via a model based on machine learning, d) determining a set of element arrangements with permutations for elements at each possible element position, and e) determining the element arrangement with the smallest ratio of the number of elements for the space and the total element work area from the ascertained set of element arrangements.

### CROSS-REFERENCE TO RELATED APPLICATIONS

This is a U.S. national stage of application No. PCT/EP2022/083915 filed 30 Nov. 2022. Priority is claimed on European Application No. 21211880.6 filed 2 Dec. 2021, the content of which is incorporated herein by reference in its entirety.

### BACKGROUND OF THE INVENTION

The invention relates to a computer program, an electronically readable data carrier, a data carrier signal and a computer-implemented method and a device for positioning technical elements in a space of a building, where the elements each have an element work area.

### 2. DESCRIPTION OF THE RELATED ART

When constructing buildings, it is often necessary to dimension and implement fire detector systems, sprinkler systems, wireless radio networks, heating systems or ventilation systems within individual spaces.

A system can be created from multiple corresponding elements, where the complexity and costs are significantly influenced by a corresponding planning process.

Such systems have hitherto frequently been dimensioned manually, using experienced engineers or by performing parametric calculations, which can however become extremely complex.

In the prior art, for example, an average number of elements per square meter of space is simply assumed, for example, in order to perform detailed planning, although this does not always result in an optimal system design.

In this case, a complex and hence somewhat undesired verification is necessary, in particular when ascertaining work areas of the positioned elements.

### SUMMARY OF THE INVENTION

In view of the foregoing, it is therefore an object of the invention to provide an automated solution to positioning tasks in order to achieve optimal positioning of elements in a space, thus enabling better, faster and more cost-effective performance of the positioning and to also create a digital model of the positioned elements.

These and other objects and advantages are achieved in accordance with the invention by a computer-implemented method comprising:
a) providing the geometry of the space via a space model,
b) determining a set of possible element positions for the positioning of the elements from the space model, taking into account predetermined positioning rules for the space,
c) ascertaining the number of elements for the space with the aid of a model based on machine learning,
d) determining a set of element arrangements with permutations for the number of elements at each of the possible element positions by:
   d1) defining element locations at the possible element positions for the ascertained number of elements, taking into account predetermined technical positioning rules for the elements as an element arrangement, and
   d2) ascertaining an aggregate total element work area for the space aided by the element arrangement and the respective element work areas, and
e) determining the element arrangement with the smallest ratio of the number of elements for the space and the total element work area from the ascertained set of element arrangements.

As a result, it is possible to dimension systems with connected, distributed system elements in the spaces as early as the planning phase, further meaning that problems can be identified and solved at an early stage.

This capability results in shorter planning processes, simpler and more cost-effective design adjustments, and material savings thanks to more efficient solutions.

In addition, the data collected during the configuration process supplies valuable information about buildings and helps with the integration of further systems and facilities with the aid of digital building data (Building Information Modeling (BIM)).

The elements in a space are technical elements, such as sensors and actuators, and form a common system, in which the work areas of individual elements are aggregated with the aid of the selected positions in the space into a total work area of all elements in the space of the building.

Using digital representations, the elements are taken into account and embedded in the model as respective element positions.

The element arrangement is likewise a digital representation in the form of a model and comprising previously determined element positions.

The number of elements for the space is ascertained with the aid of a model based on machine learning, in order to provide as large a work area as possible, i.e., a coverage area for the effect of a single element, for example, a receiving area for a sensor.

The elements are preferably elements of a monitoring system, because a monitoring system can be dimensioned particularly easily in accordance with the invention, because to determine the respective work area only an influencing variable toward the element need be taken into account and not a bidirectional influence in the case of bidirectional elements, i.e., sending and receiving elements such as radio communication modules, in which reflection behavior due to outgoing signals must be taken into account, which in turn means a high level of effort.

In this connection, the work area of an element is understood to mean the geometric area in which either an element formed as a sensor has a detection area of the sensor or an element formed as an actuator has an effective or control area of the sensor.

Here, a sensor and an actuator each define a unidirectional element, in which the receiving direction of the sensor, i.e., the direction toward the sensor, or the actuator direction, i.e., the direction away from the actuator, is present.

An element can also be structured as a combined sensor and actuator, for example, a combined transmitter and receiver of a radio system, as a result of which a bidirectional element is formed and defined.

The work area of an element can therefore additionally be described with one or more geometric working directions of the element.

The work area of a unidirectional element is, for example, the sensor receiving area of a fire detector element.

The work area of a bidirectional element is, for example, the transmission/receiving area of a WLAN radio communication module or radio bus system.

In this connection, an aggregate total element work area is understood to mean a superposition, i.e., the summation of individual element work areas, i.e., an additively resulting area in the space, which is composed of the individual areas involved. This results in a jointly acting arrangement of the elements with optimal, synergistic and technical effect.

Element locations are understood to mean a selected local position of an element in the space, in other words, for example, at coordinates in the space, which corresponds to a digital representation in the model.

The set of element arrangements is defined by permutations of the elements in the ascertained number of possible element positions that were determined in step b).

As a result of the invention, it is possible to achieve a reduction in possible permutations, due to a smart preselection of the number of elements, as a result of which the computational effort can be considerably reduced compared to a straightforward parameterization and thus the optimal arrangement is achieved in a particularly efficient manner.

In this connection, the optimal element arrangement is obtained due to a particularly favorable low ratio between the number of elements and the obtained aggregate total element work area for the space, i.e., in order to achieve as large as possible a total element work area per element, taking account of predetermined positioning rules for the space.

The technical rules are technical dimensioning rules, for example, minimum or maximum distances between individual technical elements or elements of the space, such as walls, doors, windows or pipes, as well as system specifications, such as a minimum number or a maximum number of elements in the system, or other technical parameters that influence the system design.

In other words, for an optimal arrangement with as few elements as possible as large as possible a total element work area should be achieved, in compliance with regulatory requirements, but taking account of predetermined positioning rules for the space in accordance with step b).

As a result of the favorable and targeted selection of criteria, the optimal solution for element positioning can be found. These criteria can correspond to possible target or system parameters, such as an optimal cable length for favorable latency, simple installation for low system complexity, special cabling requirements from a regulatory point of view, a redundant system configuration for high safety requirements or simply a selected number of elements for the space for an efficient system in combination with the widest possible aggregate total element work area of the individual elements for the space, i.e., the smallest possible shaded area in the entire work area.

The targeted selection of criteria occurs inter alia by step b), by taking account of predetermined positioning rules for the space.

The preselection occurs by a similarity comparison with similar spaces using machine learning and the findings thereof about an achievable coverage or a corresponding work area through the derived number of elements.

This aspect results in an improved initial situation in the planning and thus in optimized element positioning.

In one embodiment of the invention, the following step is further implemented:
f) positioning the elements at the positions of the element arrangement determined in step e).

Additionally or alternatively, a corresponding digital space model or building model can be generated, which comprises the ascertained optimal element arrangement.

As a result of step f), a physical effect is achieved for the element arrangement, i.e., an optimally, synergistically and technically acting, common arrangement of the elements. As a result, a low-complexity system that is efficient and simple to construct and operate is created.

In this connection, the positioning of elements is understood to mean the physical arrangement or attachment of technical elements in the space.

In one embodiment of the invention, the elements are sensors such as fire detectors, and the elements are preferably elements of a monitoring system.

As a result, the method can be applied particularly easily.

In another embodiment of the invention, the elements comprise actuators such as heating controllers or receiving units such as air intake units or discharging units such as air extraction units. In this case, the work area of an element is, for example, the radius of action of a fan element.

In a further embodiment of the invention, the elements comprise emitters for extinguishing water, i.e., sprinklers, or radio, such as wireless radio communication modules.

The work area of a unidirectional element is, for example, the extinguishing area of a sprinkler element. Both fire detectors and flashing detector lights, which are emitters, can be connected to a fire detector control panel via a common line.

In another embodiment of the invention, the model is generated and trained based on machine learning with the aid of reference spaces with installed reference elements, and the geometry of a reference space with reference elements and a corresponding aggregate total work area for each reference element is taken into account within the model. Here, it is particularly favorable if a genetic algorithm is used in the generation and in the training for the model based on machine learning, i.e., the model is determined by a genetic algorithm on the basis of machine learning.

Evolutionary algorithms (or also genetic algorithms) are a form of development of Artificial Intelligence. More precisely, it is a form of Deep Learning, which in turn represents a sub-area of “Machine Learning” (ML). Evolutionary algorithms are oriented to biological evolution and the development patterns thereof.

As a result of the favorable and targeted selection of three criteria, it is possible to find the optimal solution for element positioning in a particularly simple manner.

A two-fold criterion lies in the favorable choice from multiple possible target or system parameters, such as an optimal line length for a favorable latency, simple installation for low system complexity, specific requirements for the cabling from a regulatory point of view, a redundant system configuration for high safety requirements or simply a selected number of elements for the space for an efficient system in combination with a widest possible aggregate total element work area of the individual elements for the space, i.e., as small as possible a shaded area in the total work area.

A further criterion lies in the favorable choice of a particularly advantageous algorithm based on machine learning, such as the application of genetic algorithms.

As a result, previously ascertained expert knowledge is employed particularly efficiently to use similar properties for spaces and elements and to apply them for the space to be examined.

These similar properties for spaces, for example, relate to geometries and building structures, as well as the number of elements and the individual and common coverage areas thereof.

Hence, in one embodiment of the invention, the predetermined positioning rules for the space comprise minimum distances from walls or space openings, or a predefined position grid for possible element positions in the space.

In another embodiment of the invention, the predetermined positioning rules for the elements comprise maximum distances between individual elements or preferred installation positions.

The objects and advantages are also achieved in accordance with the invention by a via which the inventive method is implemented.

The device with a processor and a memory serves to calculate locations at which technical elements can be positioned in a space of a building, and the ascertained locations in the sense of a jointly acting arrangement of the elements achieve an optimal, synergistic technical effect.

The objects and advantages are also achieved in accordance with the invention by a computer program, comprising control information or commands, which when executed by a computer cause the computer to perform the inventive method.

The objects and advantages are also achieved in accordance with the invention by an electronically readable data carrier with readable control information or commands stored thereon, which comprise at least the computer program which is configured such that when the data carrier is implemented in a computing device performs the inventive method.

The inventive object is also achieved by a data carrier signal, which transmits the inventive computer program.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below using an exemplary embodiment illustrated in the accompanying drawings, in which:

FIG. 1 schematically shows an exemplary embodiment of the inventive method;

FIG. 2 shows a flow diagram of the inventive method;

FIG. 3 shows an exemplary space model;

FIG. 4 shows a view from above of the space model of FIG. 3;

FIG. 5 shows a rotated view of FIG. 4;

FIG. 6 shows the view of FIG. 5 with a grid;

FIG. 7 shows the view of FIG. 6 after application of positioning rules for the space;

FIG. 8 shows the view of the space of FIG. 3 with automatically ascertained sensor positions; and

FIG. 9 shows a comparison of manually ascertained sensor positions with inventively ascertained sensor positions.

### DETAILED DESCRIPTION OF THE EXEMPLARY EMBODIMENTS

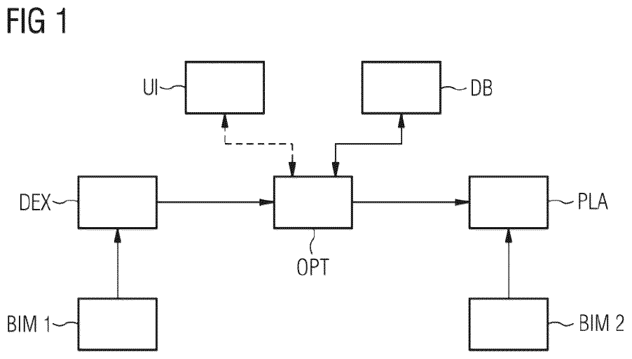

FIG. 1 schematically shows an exemplary embodiment of the inventive method for positioning elements in a space R of a building B.

The method is computer-implemented in a computing device with a memory.

The space can be part of a building.

Sensors such as fire detectors can be used as elements for optimal positioning, where the fire detector sensors each have an area in their respective surroundings, in which, for example smoke, soot or dust of a fire is detected.

The elements each have an element work area, i.e., a detection area in which the element can interact with the surroundings.

The inventive method can, for example, also be applied to actuators such as heating controllers, as well as to receiving units such as air intake units or discharging units such as air extraction units.

The inventive method can, for example, also be applied to the optimal positioning of wireless networks, such as WLANs, Bluetooth-Mesh networks or wireless electrical installation networks in accordance with the Zigbee, radio KNX, Z-Wave, EnOcean standard or for other proprietary systems.

The inventive method can further also be used when planning wired communication systems, for example, when planning access points such as for LAN switches, as well as for sockets for the power supply.

The inventive method can likewise be used in other systems of building automation, building system technology or building communication.

In this example the method is used to ascertain an optimal fire detector arrangement for a space.

The optimal arrangement in this case relates to an optimal ratio between a minimum number of fire detector elements and a maximum sensor detection area of the fire detectors overall.

Initially, space data is detected in the form of a first BIM model BIM1. A BIM model consists of data that is generally structured by an information model for digital building modeling, which can manage not only geometric but also alphanumeric data. With the aid of a BIM model, all aspects of the future building should be mapped with computer support as a “digital twin”.

The Industry Foundation Classes (IFC) are an open standard in the construction industry for the digital description of building models (Building Information Modeling). What is defined is the IFC from buildingSMART International (bSI), formally known as the Industrial Alliance for Interoperability (IAI). The IFC are registered under International Organization for Standardization standard 16739 (ISO-16739).

The logical building structures (for example, Window-Opening-Wall-Floor-Building), the associated properties (attributes) and the optional geometry are mapped. This makes it possible, inter alia, to transfer complex 3D planning data with the construction elements and descriptive attributes between construction software systems. IFC is supported by extensive software for the exchange of building data.

Areas of application are, for example, 2D/3D CAD, static and energy calculations, quantity and cost determination and in facility management. The exchange occurs using IFC files with the extension *.ifc. In addition, IFC files in the XML standard (*.ifcXML) and zipped IFC files (*.ifcZIP) can also be used.
buildingSMART maintains a database containing all programs which claim to support IFC: IFC software database.
buildingSMART additionally offers a certification program to all software manufacturers wishing to subject their IFC interface to an independent quality check.

A data extraction DEX then occurs, in which, for example, the geometry of the space and space elements, such as not only the walls but also openings such as doors or windows or other building structure elements such as columns, are ascertained, where a BIM model of the space is generated.

A space model can, for example, be created manually based on plans and CAD drawings.

Likewise, with the aid of a NavVis scan a point cloud can be created or collected, which is mapped into a space model.

A BIM model captured in this way can be provided to the inventive method in step a).

Defined objects and the geometry thereof can be derived from the IFC model.

Then, in step OPT, the optimal fire detector arrangement is determined, which is explained in detail in the following figure.

An advantageous prerequisite for the successful use of an optimization algorithm, as in the present example of the “Multi-Objective Genetic Algorithm”, is the mathematical formulation of the optimization task.

Furthermore, predetermined positioning rules for the elements are ascertained, for example, using technical guidelines and standards regarding construction technology or preventive fire protection, such as maximum distances between individual fire detector elements or preferred installation positions of the fire detectors, and are applied to the previously generated BIM model of the space, i.e., are brought into a machine-readable form.

A user interface UI enables parameters to be input during the optimization OPT. Alternatively, recourse can also be had to predetermined parameters, for example, from a database DB.

Finally, in step PLA the positioning occurs in accordance with the previously ascertained arrangement, for which a corresponding BIM model BIM2 of the space is generated, which contains not only building information but now also information about the fire detector installation.

In this way further information, such as for heating, ventilation, wireless network or electrical installation, can be taken into account in the BIM model.

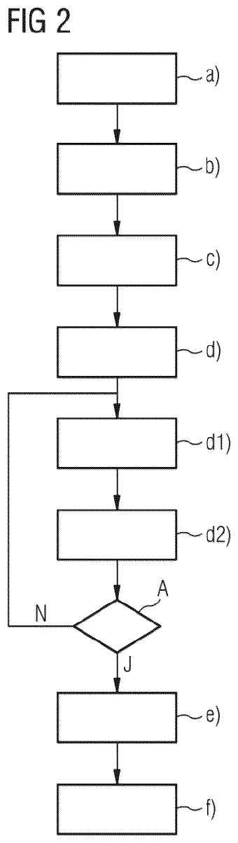

FIG. 2 shows a flow diagram of the inventive method, which is implemented by a corresponding computational device with a processor and a memory.

A corresponding implementation of the method in the form of a computer program product which, for example, comprises executable instructions, control information or a data carrier signal, is clear to the person skilled in the art and is hence not illustrated separately.

The ascertained optimal positions represent a physical arrangement and their technical effect of the optimal arrangement is hence equivalent to the one that is determined in the model. Hence, the simulation of the system using the model or the method contributes to the solution of the technical problem and solves it.

As a result of the method a BIM model with the ascertained optimal positions can be generated after step e) and, for example, can already be used in the planning phase for an error analysis.

It should readily be understood an ascertained dataset can also be used for training an ML model.

The following steps are performed in this case:
a) providing the geometry of the space R via a space model BIM1,
b) determining a set of possible element positions for the positioning of the elements from the space model, taking into account predetermined positioning rules for the space R,
c) ascertaining the number of elements for the space with the aid of a model based on machine learning,
d) determining a set of element arrangements with permutations for the number of elements ascertained in step c) at each of the possible element positions by:
   d1) defining element locations at the possible element positions for the ascertained number of elements, taking into account predetermined positioning rules for the elements as an element arrangement,
   d2) ascertaining an aggregate total element work area for the space with the aid of the element arrangement and the respective element work areas,
e) determining the element arrangement E1-E3 with the smallest ratio of the number to elements E1-E3 for the space R and the total element work area from the ascertained set of element arrangements, and
f) positioning the elements at the positions E1-E3 of the element arrangement in the space R determined in step e).

Here, the model is generated and trained based on machine learning with the aid of a plurality of reference spaces with installed reference elements.

This occurs, for example, with a Multi-Objective Genetic Algorithm as described in Holland, John H. “Generic Algorithms”, Scientific American, 1992:66-73.

Alternatively, another “Deep Neural Network” can also be used.

The model in each case takes into account the geometry of a reference space with the number of reference elements used.

The model in each case further comprises an aggregate total work area for the respective space with the reference elements.

Steps d1) and d2) are followed by a query A as to whether the element arrangements have already been ascertained for all permutations.

If this is not yet the case, then two Ns, steps d1) and d2), are repeated.

Otherwise, step e) is continued in branch Y.

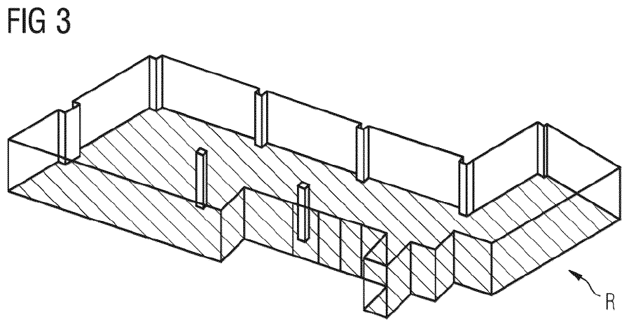

FIG. 3 represents a spatial view for an exemplary space model of the space R.

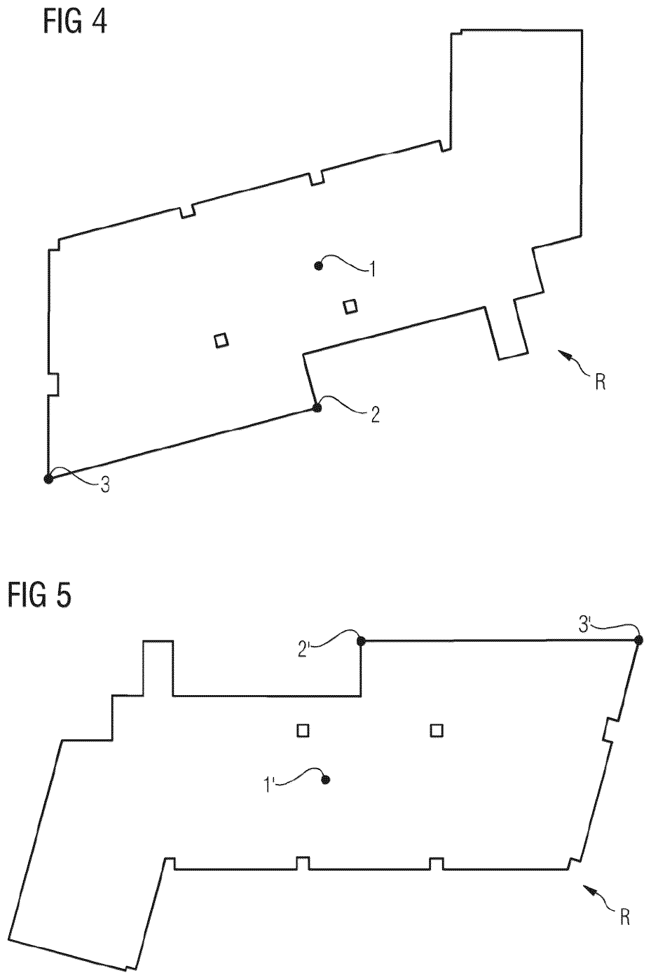

FIG. 4 shows a view from above of the space model of FIG. 3.

There is a complex geometry of the space R with two columns in the center of the space.

Three points 1-3 for the space R are shown, in order to characterize the coordinate system.

FIG. 5 shows a rotated view of FIG. 4, where the three points 1-3 have been transformed by a rotation into a coordinate system advantageous for the subsequent optimization, namely into the three points 1′-3′.

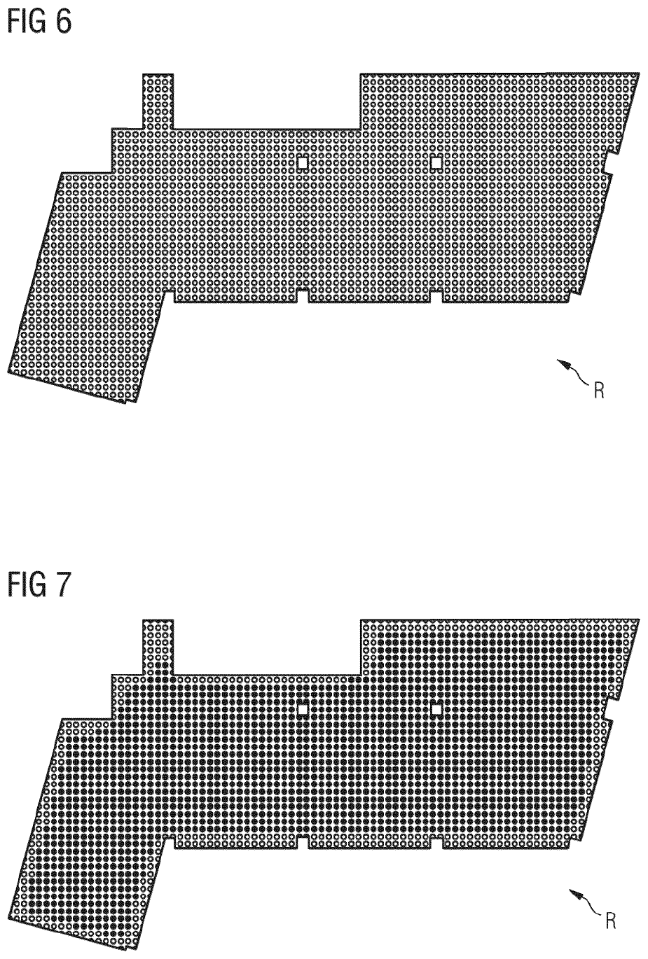

FIG. 6 shows the view in accordance with FIG. 5, where a grid for permissible element positions is generated, in order to simplify the optimization and for example to provide a minimum distance between individual elements.

This occurs with the aid of predetermined positioning rules for the elements, in order, for example, to take into account maximum distances between individual elements for the preferred seamless compliance with a sensor detection area or preferred installation positions.

FIG. 7 represents the permissible element positions after application of positioning rules for the space. For example, in this case, minimum distances from walls or space openings are taken into account.

Furthermore, preferred installation positions can as a result also be provided, in order, for example, to ensure that installation cables run straight.

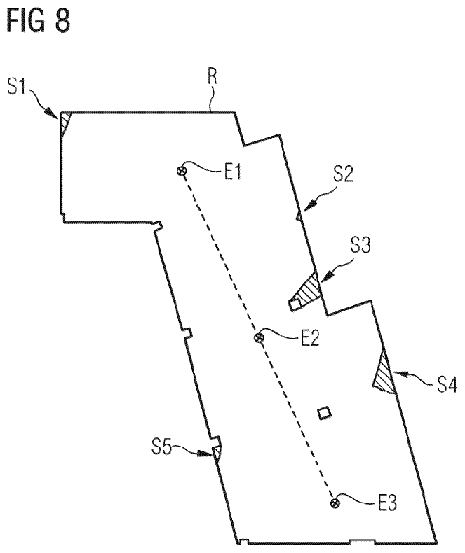

FIG. 8 shows the view of the space R with automatically ascertained sensor positions.

It can be seen that with three fire detectors E1-E3 a very good detection area for the space R can be achieved, since shaded areas S1-S5 only attain a very small size.

The sensors E1-E3 lie along a straight line and can be installed easily and inexpensively.

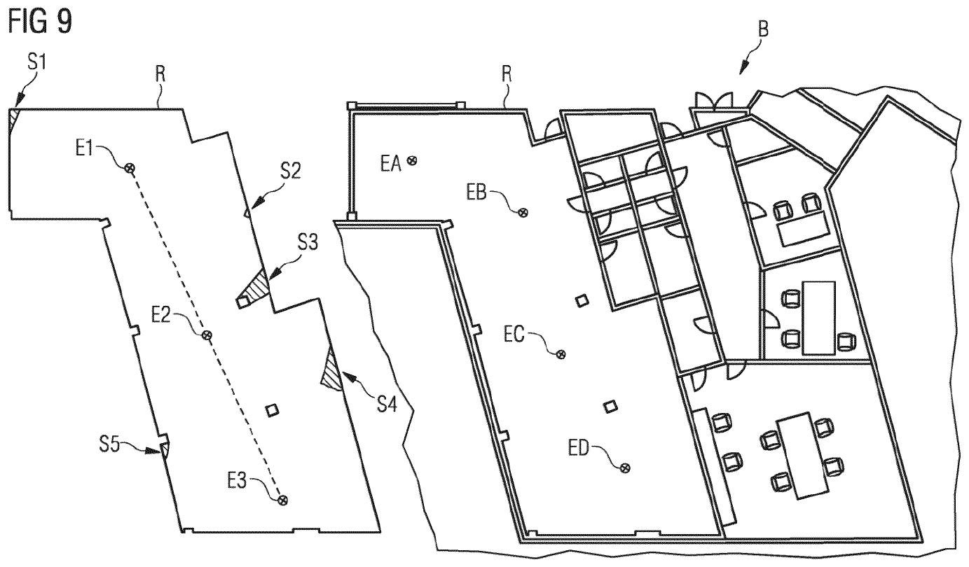

FIG. 9 represents a comparison of manually ascertained sensor positions EA-ED with inventively ascertained sensor positions E1-E3 for the space R in the building B.

The arrangement with the sensors E1-E3 requires three sensors for a very good detection area. However, the arrangement with the sensors EA-ED requires four sensors for a comparable detection area.

Furthermore, the arrangement with the sensors EA-ED is more complex to construct, because a much more complicated installation is required in accordance with the applicable installation rules and standards.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A computer-implemented method for positioning technical elements in a space of a building, the elements each having an element work area, the method comprising:
a) providing a geometry of the space via a space model;
b) determining a set of possible element positions for the positioning of the technical elements from the space model while taking into account predetermined positioning rules for the space;
c) ascertaining a number of technical elements for the space aided by a model based on machine learning;
d) determining a set of element arrangements with permutations for the number of technical elements at each determined possible element position by:
d1) defining element locations at the possible element positions for the ascertained number of technical elements while taking into predetermined technical positioning rules for the technical elements as an element arrangement; and
d2) ascertaining an aggregate total element work area for the space aided by the element arrangement and the respective element work areas; and
e) determining the element arrangement with a smallest ratio of the number of technical elements for the space and the total element work area from the ascertained set of element arrangements.

15. The method as claimed in claim 14, further comprising:
f) positioning the technical elements at the positions of the element arrangement determined in step e).

16. The method as claimed in claim 14, wherein the technical elements are sensors.

17. The method as claimed in claim 15, wherein the sensors are fire detectors of a monitoring system.

18. The method as claimed in claim 14, wherein the technical elements comprise actuators

19. The method as claimed in claim 18, wherein the actuators comprise one of heating controllers, receiving units and discharging units.

20. The method as claimed in claim 19, wherein the receiving units comprise air intake units and the discharging units comprises air extraction units.

21. The method as claimed in claim 14, wherein the technical elements comprise emitters for extinguishing water or radio.

22. The method as claimed in claim 14, wherein the model is generated and trained based on machine learning aided by reference spaces with installed reference elements, the geometry of a reference space with reference elements and a corresponding aggregate total work area for the reference elements being each taken into account in the model.

23. The method as claimed in claim 14, wherein the model is determined by a genetic algorithm based on machine learning.

24. The method as claimed in claim 14, wherein the predetermined positioning rules for the space comprise minimum distances from walls or space openings, or a predefined position grid for possible element positions in the space.

25. The method as claimed in claim 14, wherein the predetermined positioning rules for the technical elements comprise maximum distances between individual technical elements or preferred installation positions.

26. A device for positioning technical elements in a space, comprising
a processor; and
memory;
wherein the technical elements each have an element work area,
wherein the processor is configured to:
a) provide a geometry of the space via a space model;
b) determine a set of possible element positions for the positioning of the technical elements from the space model while taking into account predetermined positioning rules for the space;
c) ascertain a number of technical elements for the space aided by a model based on machine learning;
d) determine a set of element arrangements with permutations for the number of technical elements at each determined possible element position by:
d1) defining element locations at the possible element positions for the ascertained number of technical elements while taking into predetermined technical positioning rules for the technical elements as an element arrangement; and
d2) ascertaining an aggregate total element work area for the space aided by the element arrangement and the respective element work areas; and
e) determine the element arrangement with a smallest ratio of the number of technical elements for the space and the total element work area from the ascertained set of element arrangements.

27. A computer program encoded with commands, which when executed by a processor of computer cause the computer program to perform the method as claimed in one claim 14.

28. An a non-transitory electronically readable data carrier with readable control information stored thereon, the control information comprising at a computer program which when executed by a computational device, causes positioning of technical elements in a space of a building, the elements each having an element work area, the computer program comprising:
a) program code for providing a geometry of the space via a space model;
b) program code for determining a set of possible element positions for the positioning of the technical elements from the space model while taking into account predetermined positioning rules for the space;
c) program code for ascertaining a number of technical elements for the space aided by a model based on machine learning;
d) program code for determining a set of element arrangements with permutations for the number of technical elements at each determined possible element position by:
d1) defining element locations at the possible element positions for the ascertained number of technical elements while taking into predetermined technical positioning rules for the technical elements as an element arrangement; and
d2) program code for ascertaining an aggregate total element work area for the space aided by the element arrangement and the respective element work areas; and
e) program code for determining the element arrangement with a smallest ratio of the number of technical elements for the space and the total element work area from the ascertained set of element arrangements

29. A data carrier signal, which transmits the computer program as claimed in one of claim 27.
